(19) United States
(12) Patent Application Publication
(10) Pub. No.: US 2025/0332603 A1
(43) Pub. Date: Oct. 30, 2025

(54) CAPSULE FOR LIQUID, POWDER, OR EMULSION WITH SHOCK ABSORBING FEATURES

(71) Applicant: SILGAN DISPENSING SYSTEMS AND PACKAGING DO BRASIL INDUSTRIA DE EMBALAGENS LTDA, RICHMOND, VA (US)

(72) Inventors: Noedir MILAN, Jundiai (BR); Kleber HIDEAKI KODAMA, Jundiai (BR); Edenilson ALDO FADEL, Jundiai (BR)

(21) Appl. No.: 18/855,453

(22) PCT Filed: Apr. 13, 2022
(86) PCT No.: PCT/BR2022/050131

§ 371 Date: Oct. 9, 2024

(51) Int. Cl. B05B 11/00; B05B 11/02; B05B 15/30

(52) U.S. Cl. CPC B05B 11/0054; B05B 11/0083; B05B 11/02; B05B 15/30

(57) ABSTRACT

A capsule (1,10) including a body (13,113) and a piston (14,114) defining at least partially a reservoir (15,115) of the capsule, a first one of said body (13,113) and said piston (14,114) being displaceable relative to a second one of said body (13,113) and said piston (14,114) in a bottom direction (A) from a closed position to an open position, the capsule (1,100) including a stop (16,116) for preventing a displacement of the first one of said body (13,113) and said piston (14,114) relative to the second one of said body (13,113) and said piston (14,114) from the closed position in the direction opposite to the bottom direction (A), wherein the first one of the body (13,113) and the piston (14,114) includes shock absorbing features (17,117) extending beyond the second one of said body (13,113) and said piston (14,114) in the bottom direction (A) in the closed position.

### BACKGROUND OF THE INVENTION

### Field of the Invention

Embodiments of the invention relate to a capsule intended to be filled with a liquid, a powder, emulsion or other product. The capsule provides an enhanced resistance to inadvertent opening in order to prevent any spill of liquid or powder. Other embodiments relate to a capsule filled with the liquid or powder, emulsion or other product. In still other embodiments of the invention, a dispensing system including a container having a container body containing a liquid, a capsule containing a liquid, powder, emulsion or other substance for dispersion into the container, a closure cap, and a dispensing unit which may include a dip tube.

### Description of Related Art

Existing capsules disclosed in U.S. Pat. No. 6,290,100 contain a concentrate product is positioned on the neck of a container containing a liquid diluent. The capsule comprises a cylindrical body and a piston inside the body in a releasable sealing engagement with the body. The piston slides inside the body and is maintained inside the body by friction against an inner wall of the body. The body comprises a top open end and a bottom open end. The bottom open end is closed by the piston that extends radially up to the inner wall of the body. The piston thus forms a closed bottom end of the capsule. A cap comprising a dispensing unit such as a pump is plugged on the neck of the reservoir. The cap comprises a projection that penetrates through the top open end of the body and pushes the top extremity of the piston, inducing a sliding of the piston inside the body. The sealing between the piston and the body is released. The bottom of the capsule is open and the concentrate product of the capsule is discharged in the container and mixes with the liquid diluent. A dip tube linked to the pump passes through the capsule up to mixed liquids in the container and feeds the pump with the mixed liquid for dispensing. Once the container is empty, the capsule can be removed and replaced by another capsule filled with the concentrate product.

There nevertheless exists some drawbacks to these existing capsules. The movable radially extending piston supports the weight of the liquid, powder or emulsion and is entirely located inside the body. When the capsule drops and hurts a support, only the body is submitted to the force exerted by the support and not the piston. The piston, and especially the radially extending portion of the piston, is submitted to the inertia force of the liquid, powder or emulsion inside the capsule that is abruptly deaccelerated at the time of the shock. No force counterbalances on the piston the liquid, powder or emulsion inertia force. As a consequence, the piston is displaced, the seal of the bottom of the capsule is broken down and the liquid, powder or emulsion drops out of the capsule.

Moreover, even in the absence of shock, breaking up of the seal of the bottom by the capsule may happen simply by abrupt handling of the capsule without any shock against a support. When the capsule is shaken, the deacceleration of the liquid, powder or emulsion inside the capsule creates an inertia force of sufficient magnitude to counterbalance the friction force of the piston on the inner face of the body and to displace the piston, leading to a leak of product.

Moreover, the capsule according to this prior art is cumbersome to remove from the neck of the body. The capsule is provided on its top end with a thin flange that rests on the upper surface of the neck of the container or on an internal structure of the neck. To change the empty capsule and replace it with a full one, the flange has to be grasped by a user, if possible, and lifted from the neck. This manipulation is complicated because of the small thickness of the flange of the capsule or simply because the flange rests inside the neck. If any liquid had spilled out of the container and has wet the neck, the user's hand may be spoiled by the liquid. Moreover, it is not recommended to put the container upside down to separate the flange of the capsule from the neck as any liquid remaining in the container would spread out of the container.

### BRIEF SUMMARY OF THE INVENTION

Certain embodiments of the invention include a capsule intended to be positioned through an aperture of a container, extending from a positioning side for positioning said capsule towards a bottom side opposite to the positioning side along a bottom direction, the capsule including:
a body and a piston defining at least partially a reservoir of the capsule to store a product and being in a releasable sealing relationship to seal the reservoir
a first one of said body and said piston being displaceable relative to a second one of said body and said piston in said bottom direction from a closed position corresponding to the seal of the reservoir to an open position corresponding to an opening of said reservoir to discharge said product,
the capsule including a stop for preventing a displacement of the first one of said body and said piston relative to the second one of said body and said piston from the closed position in the direction opposite to the bottom direction
wherein the first one of the body and the piston includes shock absorbing features extending beyond the second one of said body and said piston in the bottom direction in the closed position.

According to certain embodiments of this invention, when a force exerted on the piston or on the body that would tend to open the capsule, when the bottom side of the capsule hits a support, is counterbalanced by an opposite force, preventing inadvertent opening of the capsule.

In one embodiment, the capsule is open up by displacement of the piston in the bottom direction relative to the body. When the capsule drops and hits a support like a floor and a surface of a table, the inertia force of the liquid, powder or emulsion inside the capsule tends to open the capsule by displacement of the piston in the bottom direction relative to the body. As the shock absorbing features extend beyond said body, they are first in contact with the support. The support then exerts a force on the piston that counterbalances the inertia force exerted by the liquid, powder or emulsion. The piston is forced towards the stop. The opening of the capsule is hindered.

In another embodiment in which the capsule is open by displacement of the body in the bottom direction relative to the piston, when the capsule hits a support, the inertia force of the liquid, powder or emulsion inside the capsule tends to open the capsule by displacement of the body in the bottom direction relative the piston. The support hits shock absorbing features of the body. The support then exerts a force on the body that counterbalances the inertia force exerted by the liquid, powder or emulsion. The body is forced towards the stop. The opening of the capsule is hindered.

According to certain embodiments that can be taken together or separately:
the shock absorbing features are integral with the first one of said body and said piston. The number of elements of the capsule can then be reduced. In such embodiments, the shock absorbing features do not necessitate an increase of the manufacturing and assembly cost by the introduction of an additional element.
the shock absorbing features may include a flat bottom face substantially orthogonal to the axis of the capsule, so that the capsule can rest on a support.
the shock absorbing features may be made of a resilient material. A part of the energy of the shock can then be absorbed by the shock absorber.
the shock absorbing features may include one or more tubular projections extending in the bottom direction from a plate of the piston, said plate defining a bottom of the reservoir in said closed position. Due to the void inside a tubular projection, the shock absorbing features can deform easily so that a part of the energy of the shock vanishes in the elastic deformation. The plate has a double function in that it provides a bottom to the reservoir and supports the shock absorber.
at least one of the body and the piston may include guiding features for the relative displacement of said body and said piston. The guiding features may allow a good relative displacement of the piston and the body without any biasing of the piston relative to the body when the capsule has to be open up.
the piston includes a shaft
an extremity of the shaft of the piston protrudes out of the inner hollow tube above the flange.
the capsule may include latching features to maintain the piston and the body in the closed position. Even in the absence of shock, shaking the capsule and handling it abruptly is likely to create an acceleration on the liquid, powder or emulsion leading to an inertia force exerted on one of the piston and the body and to the opening of the capsule. One or more latching features may reinforce the steadiness of the closed position.
the body includes an outer body in releasable sealing relationship with a sealing lip of said piston and an inner hollow tube linked to the outer body by an annular web, a shaft of said piston sliding inside said inner hollow tube. Advantageously the inner hollow tube defines a part of the reservoir of the capsule while the shaft of the piston remains out of the reservoir and out of the contact of a liquid filling the reservoir. The annular web defines a top of the reservoir.
the stop may consist in the inner hollow tube and the plate of the piston interacting together. This simple embodiment of a stop prevents movement in the direction opposite to the bottom direction without the necessity of additional element.
latching features may include a first shoulder on an inner face of the inner hollow tube of the body and a ring on the shaft of the piston, said ring cooperating with said first shoulder.
a second latching feature may include a second shoulder on an outer body inner face, said second shoulder cooperating with the sealing lip of the piston.
the sealing lip has a substantially ring shape, the sealing lip including a transitory portion with an outer face that is tilted relative to the outer body inner face and an end portion starting from the tilted portion with an outer face that is substantially parallel to and rests along the outer body inner face, the thickness of the end portion being greater than the thickness of the transitory portion, the end portion abutting on said second shoulder on the outer body inner face. Such an increase of thickness increases the rigidity of the end of the lip and consequently the strength of the second latch. As a consequence, the inadvertent opening of the capsule may be rendered unlikely.
the body may include a constriction delimitating an orifice, said piston being in releasable sealing contact with an inner face of said constriction and/or a lateral face of said orifice in said closed position, a shock absorbing feature being an outer face of said constriction. In case of a shock on a support, the inertia force created by the liquid in the capsule on the body is counterbalance by the force exerted by the support on the outer face of the body.

Other embodiments of the invention also relate to such a capsule filled with a liquid or a powder.

Still other embodiments of the invention relate to a dispensing system having a container with a container body containing a product and a neck having supported therein a capsule containing a liquid substance, a powder or an emulsion, a closure cap including a dispensing unit to dispense a fluid from the container, said closure cap including connection feature to attach the closure cap on the neck of the container and a dip tube linked to the dispensing unit and passing through said capsule into the container body to put in communication the dispensing unit with a product in the container body.

According to certain embodiments of the invention, the capsule pours the liquid substance, powder or emulsion into the container body containing the product and the liquid substance, powder or emulsion mixes with the product. The mixture may be dispensed by the dispensing system.

According to certain embodiment, the shaft of the piston is hollow and is provided with an inlet aperture and an outlet aperture and wherein the dip tube passes through the hollow shaft of the piston. The hollow shaft then ensures a pathway to the dip tube through the closed reservoir of the capsule. Such an integration of the dip tube into the capsule is particularly convenient as it is compact. In addition, an outer diameter of the dip tube is substantially equal to an inner diameter of the hollow shaft of said piston, the dip tube is force-fitted into said shaft so that the dip tube draws the capsule out of the neck when the whole dispensing unit is removed. When the liquid into the container body has been fully dispensed by the dispensing unit, the container has to be refilled and the empty capsule has to be replaced by another capsule containing a liquid, a powder or an emulsion. This embodiment is particularly convenient has the empty capsule can be easily separated from the container.

### BRIEF DESCRIPTION OF THE SEVERAL VIEWS OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1a illustrates a cross-section of a capsule according to a first embodiment of the invention;

FIG. 1b illustrates a piston of a capsule according to various embodiments of the invention;

FIG. 2 illustrates a first latch of a capsule according to various embodiments of the invention;

FIG. 3a illustrates a second latch of a capsule according to various embodiments of the invention;

FIG. 3b illustrates a shoulder on an outer body inner face of a capsule according to various embodiments of the invention;

FIG. 3c illustrates a sealing lip of a piston of a capsule according to various embodiments of the invention;

FIG. 4 illustrates a capsule positioned in the neck of a container;

FIG. 5 illustrates a top part of a dispensing system according to embodiments of the invention;

FIG. 6a illustrates a cross-section of a bottom side of a capsule according to various embodiments of the invention; and

FIG. 6b illustrates a cross-section of a bottom side of a capsule according to various embodiments of the invention.

### DETAILED DESCRIPTION OF THE INVENTION

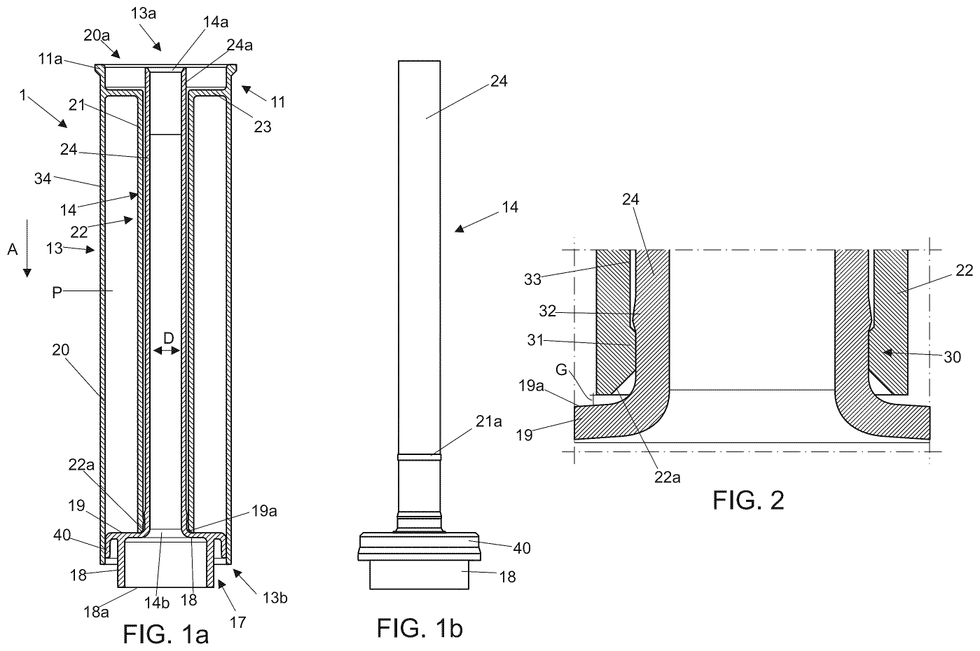

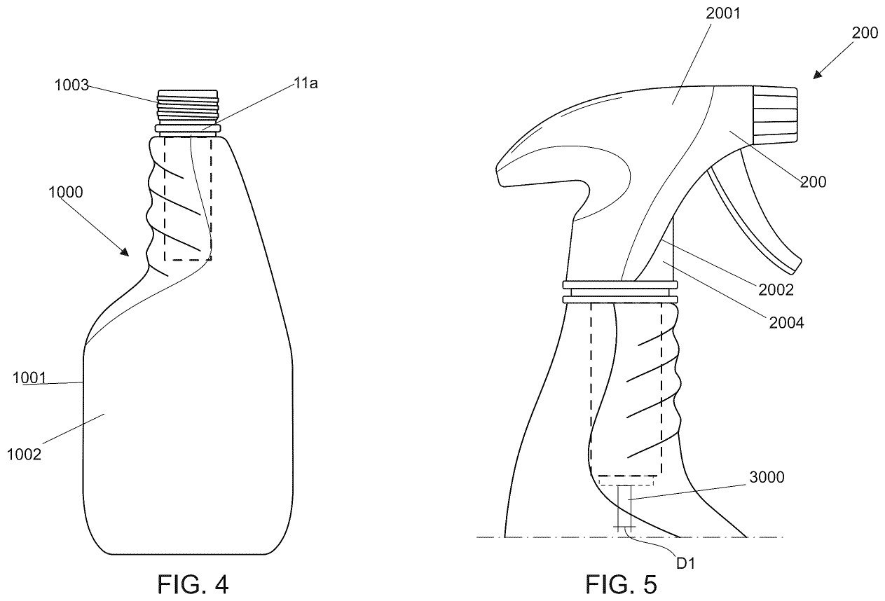

FIG. 1 illustrates a capsule according to embodiments of the invention in the closed position. The capsule 1 may include a body 13 and a piston 14, though in other embodiments the capsule may be made of more than two elements. According to certain embodiments, a capsule may be substantially cylindrical in shape with an axisymmetric axis X. The capsule may include a positioning side 11 and a bottom side 12. The capsule may be positioned on the neck of a container via its positioning side 11 and especially via a flange 11a that is able to rest on the top surface of the neck of a container as illustrated in FIGS. 4 and 5.

In some embodiments of the invention a body 13 may include an outer body 20 that extends from the positioning side 11 to the bottom side 12 of the capsule. The body 13 may have two open ends 13a and 13b on the positioning side and the bottom side respectively. The flange 11a may be integral with the body 13 in certain embodiments. In other embodiments, a flange 11a pertains to a distinct element fixed to the body 13. The body may also include an inner hollow tube 22 that extends axially from a vicinity of the positioning side to the vicinity of the bottom side and is open on both extremities. The outer body 20 and inner hollow tube 22 have a tubular form and are coaxial, the axis X being the common axis. The outer body 20 and the inner how tube 22 may be linked together by an annular web 23 located close to the positioning side of the capsule. In some embodiments, the outer body 20, the inner hollow tube 22 and the annular web 23 may be integral and preferably may be made of plastic.

The piston 14 according to certain embodiments includes a hollow shaft 24, a plate 19 and a sealing lip 40. As illustrated on FIG. 1b, the body 13 and the piston 14 may include guiding features 21 for the relative displacement of said body and said piston. The hollow shaft 24 of the piston passes through and is guided by the inner hollow tube 22 of the body 13. The hollow shaft 24 and the inner hollow tube 22 of the body 13 are in close cooperation and act as guiding features 21 to guide the displacement of the piston 14 relative to the body 13. Moreover, the hollow shaft 24 may include a ring 21a that is in sealing and sliding contact with an inner face 33 of the inner hollow tube 22. This contact ensures a guiding of the piston in its displacement relative to the body 13 and the ring 21a and the inner face 33 of the inner hollow tube 22 act as guiding features 21.

The sealing lip 40 may be in releasable sealing engagement on an outer body inner face 34. A reservoir 15 of the capsule 1 is sealed to store a product P that may be a liquid, a powder or an emulsion and may be delimitated by the outer body inner face 34, the inner hollow tube 22, the annular web 23 and the plate 19 of the piston 13 in a closed position of the capsule 1.

An extremity 24a of the hollow shaft 24 of the piston 14 may protrude out of the inner hollow tube 22 above the annular web 23. By pushing the extremity 13c in a direction A, the piston 13 slides within the inner hollow tube 22 in the direction A and the sealing lip 40 slides along the outer body inner face 34 of the body until the sealing lip reaches the outlet aperture 13b of the body and that the contact between the sealing lip 40 and the outer body inner face 34 is broken. The reservoir 15 is not sealed anymore and the content of the capsule is discharged.

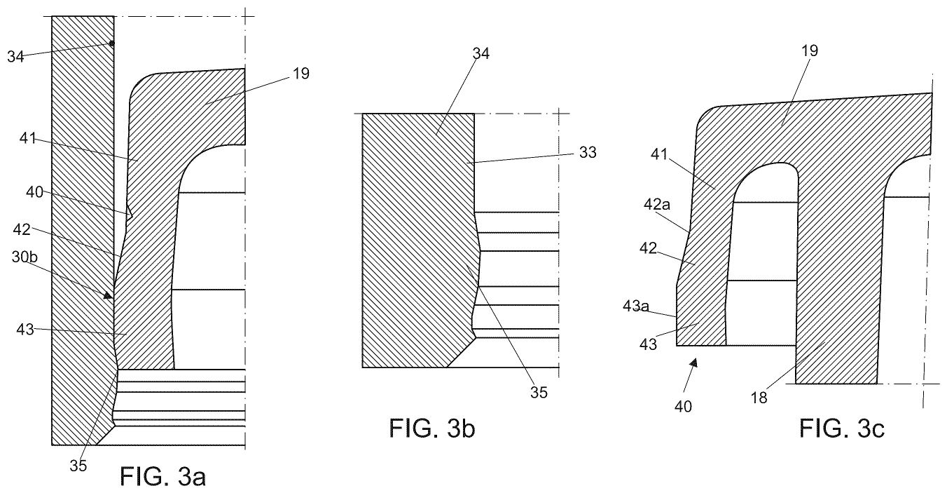

In order to prevent any inadvertent displacement of the piston 14 in the direction A relative to the body, the capsule includes latches 30a,30b, illustrated on FIGS. 2 and 3a to 3c, to maintain the piston 14 and the body 13 in the closed position.

A first latch 30a illustrated on FIG. 2 may include a first shoulder 31 on the inner face 33 of the inner hollow tube 22 of the body 13 and a ring 32 on the shaft 24 of the piston 14, said ring 32 cooperating with said first shoulder 31. This first latch 30a is in the form of a snapping relation between the first shoulder 31 and the ring 32. For displacing the piston towards the direction A, the snapping engagement of the first latch 30a and the first shoulder 31 has to be overcome by deformation of the inner hollow tube 22.

A second latch 30b, illustrated on FIGS. 3a to 3c, may also be included with a second shoulder 35 on the outer body inner face 34, said second shoulder 35 cooperating with the sealing lip 40 of the piston 14. The end portion 43 abuts on said second shoulder 35 of the outer body inner face 34. The second latch 30b may also be in the form of a snapping engagement. For displacing the piston towards the direction A, the snapping engagement has to be overcome by deformation of the sealing lip 40. Because of one or both of the latches 30a and 30b, a threshold force on the piston has to be overcame for the opening of the reservoir 15 and the discharge of its contents. Inadvertent discharge is unlikely because of the inclusion of one or more of the latches 30a and 30b.

Advantageously, the combination of these two latches 30a and 30b involving two different elements of the piston 14, increases said threshold force compared to a case in which one single latch is provided. Nevertheless, it will be understood by one skilled in the art that the capsule can also be provided with one latch without departing from the scope of the invention.

In some embodiments, a sealing lip 40 as illustrated on FIG. 3c may enable strengthening of the second latch 30b and increase the threshold force. In some embodiments the sealing lip 40 has a substantially ring shape and includes a transitory portion 42 having an outer face 42a that is tilted relative to the outer body inner face 34 and an end portion 43 starting from the tilted portion 42 having an outer face 43a that is substantially parallel to and rests along the outer body inner face 34. The thickness of the end portion 43 may be greater than the thickness of the transitory portion 42. The end portion 43 abuts on said second shoulder 35 on the outer body inner face 34. The transitory portion 42 may extend directly from the plate 19 of the piston 14. Alternatively, a first portion 41 may extend between the plate 19 and the transitory portion 42 without departing from the scope of the invention.

A capsule 1 may also include a stop 16, illustrated on FIGS. 1a and 2, for preventing a displacement of the body and the piston relative to each other in one direction from the closed position. In this embodiment, the stop 16 prevents a displacement of the piston in a direction opposite to the bottom direction relatively to the body, that is to say, in a direction opposite to the direction of displacement of the piston that enables the opening of the capsule. Especially, the stop 16 may consist in the inner hollow tube 22 and the plate 19 of the piston interacting together. More precisely, the top face 19a of the plate 19 of the piston 14 abuts against an extremity 22a of the inner hollow tube 22 when the piston is displaced from the closed position of the capsule in the direction opposite to the bottom direction A. In the absence of a stop, any force exerted on the piston 14 in the direction opposite to the bottom direction A would lead to a decrease of the volume of the reservoir 15 of the capsule and consequently an increase of pressure on the product stored in the reservoir 15. The product may then leak between the sealing lip 40 and the outer body inner face 34, especially if said product is a liquid.

As can be seen from FIG. 2, there may be a gap G between the extremity 22a of the inner hollow tube 22 and the top face 19a of the plate 19 of the piston when the ring 32 and the first shoulder 31 of the first latch 30a are in contact. Without the gap G, the first latch 30a could not be snapped. The gap G may be chosen small enough so that, once the first latch 30a is engaged, any displacement of the piston 14 in the direction opposite to the bottom direction A would not create any overpressure of the product inside the reservoir 15 that may lead to a leak of product between the lip 40 and the outer body inner face 40.

The capsule is provided with shock absorbing features 17 that extend from a first one of the body 14 and the piston 13 that is displaceable relative to a second one of the body 14 and the piston 13 in the bottom direction A to discharge the product P. The shock absorbing features 17 extend beyond the other one of said body 13 and said piston 14 in the bottom direction A in the closed position.

In the present embodiment, the shock absorbing features 17 may extend from the piston 14, that is displaceable relative to the body 13 in the bottom direction A to open the reservoir 15 from the closed position. In case the capsule drops and hurts a support, the product inside the reservoir 15 may be abruptly deaccelerated and exert an inertia force on the plate 19 of the piston. Under the effect of this force, the piston 14 is urged relative to the body 13 in the bottom direction. As the shock absorbing features 17 extend beyond the body 13, they are first in contact with the support. The support exerts a force that counterbalances the inertia force on the piston and pushes the piston in the direction of the stop 16. Then the capsule remains sealed and the spreading of the product inside the reservoir 15 is prevented.

According to certain embodiments, the shock absorbing features 17 may be integral with the piston 14, then avoiding any increase of the number of pieces of the capsule that would increase the manufacturing and assembly cost of the capsule.

According to certain embodiments, the shock absorbing features 17 may include a flat bottom face 18a substantially orthogonal to an X axis of the capsule, so that the capsule can rest on a support.

According to certain embodiments, the shock absorbing features 17 are made of a resilient material. A part of the energy of the shock is then be absorbed by the shock absorbing features 17.

According to certain embodiments, the shock absorbing features 17 may be a tubular projection 18 extending in the bottom direction A from the plate 19 of the piston, the plate 19 defining a bottom of the reservoir in closed position of the capsule. Due to the void inside the tubular projection 18, the shock absorbing features 17 can deform easily so that a part of the energy of the shock is absorbed in the elastic deformation. Advantageously, the plate 19 has a double function in that it provides a bottom to the reservoir 15 and supports the shock absorbing features 17.

FIG. 4 represents the capsule 1 positioned on a neck 1003 of a container 1000, the flange 11a resting on an internal structure of the neck 1003. The container 1000 also includes a container body 1001 containing a liquid diluent 1002. When the capsule is open, the product P which is a liquid, a powder or an emulsion stored in the reservoir 115 is poured into the container body 1001 and mixes or dissolves into liquid diluent 1002.

FIG. 5 illustrates partially a dispensing system 2000 including a container 1000 having a container body 1001 containing a liquid diluent 1002 and a neck 1003 having supported therein the capsule 1 containing a liquid substance, a powder or an emulsion. The dispensing system also includes a closure cap 2003 including a dispensing unit 2001 to dispense a fluid from the container body 1001, said closure cap 2003 including plugging features 2002 to plug the closure cap 2003 on the neck 1003 of the container 1000 and a dip tube 3000 linked to the dispensing unit 2001 and passing through said capsule 1 into the container body 1001 to put in communication the dispensing unit 2001 with the liquid diluent 1002.

The dispensing system 2000 may include a projection 2004, that may be any type of sleeve, that comes into contact with the extremity 24a of the shaft 24 of the piston 14 when the plugging features 2002 plug the dispensing system 2000 on the neck 1003 of the container 1000. During the plugging operation, the piston is then pushed and moved relative to the body 13 in the bottom direction A and the capsule 1 is open. Then, the capsule pours the liquid, powder or emulsion into the container body 1001 containing the diluent liquid 1002. The liquid, powder or emulsions mix with the diluent liquid to form a mix liquid.

The dip tube 3000 feeds the dispensing unit 2001 with the mix liquid. The shaft 24 of the piston 14 may be hollow and may be provided with an inlet aperture 14a and an outlet aperture 14b. The dip tube 3000 passes through the hollow shaft 24 of the piston. The hollow shaft 24 then ensures a pathway to the dip tube 3000 through the closed reservoir 15 of the capsule. Such an integration of the dip tube into the capsule is particularly convenient. According to certain embodiments, an outer diameter D1 of the dip tube may be substantially equal to an inner diameter D2 of the hollow shaft 24 of said piston 14. The dip tube 3000 is force-fitted into the shaft 24 so that the dip tube 30000 draws the capsule 1 out of the neck 1003 when the whole dispensing unit 2001 is removed from the container body 1001. When the mix liquid into the container body 1001 has been fully dispensed by the dispensing unit 2001, the container 1000 has to be refilled and the empty capsule 1 has to be replaced by another capsule containing a liquid, a powder or an emulsion. This embodiment is particularly convenient has the empty capsule 1 can be easily separated from the container neck 2003.

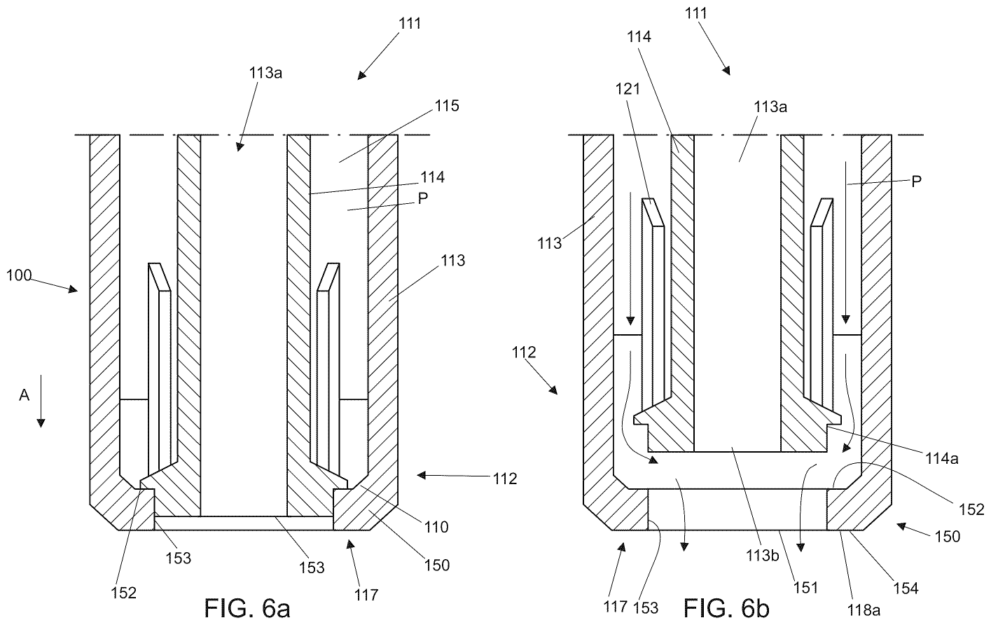

FIGS. 6a and 6b represent the bottom side 112 of a second embodiment of a capsule 100 according to the invention in closed and open position respectively. In this embodiment, a body 113 and a piston 114 delimitates a reservoir 115 of the capsule to store a product P that can be a liquid or a powder or an emulsion. The body 113 is displaced relative to the piston 114 in a bottom direction A to open the capsule and discharge the product P along the pathway indicated by the arrows on FIG. 6b. The relative displacement of the body 113 and piston 114 is guided by guiding features 121 in the form of ribs.

The body 113 includes a constriction 150 delimitating an orifice 151. The piston 114 is in a releasable sealing contact with an inner face 152 of the constriction 150 and/or a lateral face 153 of the orifice 151 in the closed position of the capsule 100. The piston 114 is set back relative to an outer face 154 of the constriction 150. In other words, the outer face 154 extends beyond the piston 114 so that in case of a shock, the support contacts the outer face 154 and not the piston 114. The outer face 154 then acts as shock absorbing features 117.

In this second embodiment, the shock absorbing features 117, namely the outer surface 154, may extend from the body 113, that is displaceable relative to the piston 114 in the bottom direction A to open the reservoir 115 from the closed position. The shock absorbing features 117 may include a flat bottom face 118a substantially orthogonal to the axis of the capsule. In case the capsule 100 drops and hurts a support, the product P inside the reservoir 15 is abruptly deaccelerated and exerts an inertia force on the inner face 152 of the body 113. Under this force, the body 113 tends to be displaced relative to the piston 114 in the bottom direction A. As the shock absorbing features 117 extend beyond the piston 114, they are first in contact with the support. The support exerts on the shock absorbing features 117 a force that counterbalances the inertia force on the body 113 and urges the body 113 in the direction of a stop 116. Then the capsule remains sealed and the spreading of the product P inside the reservoir 15 is prevented.

Finally, the stop 116 for preventing a displacement of the body 113 relative to the piston 114 from the closed position in the direction opposite to the bottom direction A may consist in an ring 114a on the piston located in the vicinity of the extremity of the piston on the bottom side 112 of the capsule 100 and the inner face 152 of the constriction 150.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

1. A capsule intended to be positioned through an aperture of a container, extending from a positioning side for positioning said capsule towards a bottom side opposite to the positioning side along a bottom direction (A), the capsule comprising:
a body and a piston defining at least partially a reservoir of the capsule to store a product (P) and being in a releasable sealing relationship to seal the reservoir,
said piston being displaceable relative to said body in said bottom direction (A) from a closed position corresponding to the seal of the reservoir to an open position corresponding to an opening of said reservoir to discharge said product (P),
a stop for preventing a displacement of said piston relative to said body from the closed position in the direction opposite to the bottom direction (A), wherein the piston includes shock absorbing features extending from said piston and beyond said body in the bottom direction (A) in the closed position.

2. The capsule according to claim 1 wherein the shock absorbing features are integral with said piston.

3. The capsule according to claim 1 wherein the shock absorbing features comprise a flat bottom face substantially orthogonal to the axis of the capsule.

4. The capsule according to claim 1 wherein the shock absorbing features are made of a resilient material.

5. The capsule according to claim 1 wherein the shock absorbing features comprise a tubular projection extending in the bottom direction (A) from a plate of the piston, said plate defining a bottom of the reservoir in said closed position.

6. The capsule according to claim 1 wherein at least one of said body and said piston comprises at least one guiding feature for the relative displacement of said body and said piston.

7. The capsule according to claim 1 wherein said piston includes a hollow shaft.

8. A capsule according to claim 1 further comprising latches to maintain the piston and the body in the closed position.

9-18. (canceled)

19. A capsule, comprising:
a body, comprising:
a positioning side;
a bottom side;
an outer body extending from the positioning side to the bottom side;
an annular web adjacent the positioning side and extending inwardly from the outer body; and
an inner hollow tube connected to the annular web and extending axially from a vicinity of the positioning side to a vicinity of the bottom side, comprising:
a first opening adjacent the annular web;
a second opening in the vicinity of the bottom side;
a first shoulder on an interior surface of the inner hollow tube adjacent the second opening;
a piston, comprising:
a hollow shaft seated in the inner hollow tube;
a plate extending outwardly from an end of the hollow shaft adjacent the bottom side;
a sealing lip extending downwardly from the plate and engaging an inner face of the outer body;
a ring on an exterior of the hollow shaft adjacent the plate and engaging the first shoulder of the inner hollow tube; and
a shock absorbing feature extending downwardly off the plate interior to the sealing lip and extending past the bottom side of the body;
a reservoir defined by the inner face of the outer body, an outer surface of the inner hollow tube, the annular web, and the plate.

20. The capsule of claim 19, wherein the positioning side of the body further comprises a positioning side end and a flange extending outwardly from an end of the positioning side.

21. The capsule of claim 19, further comprising a common axis X, wherein the outer body and the inner hollow tube are coaxial about the common axis X.

22. The capsule of claim 19, wherein the hollow shaft of the piston further comprises a ring on an outer surface thereof, wherein the ring engages an inner face of the hollow tube.

23. The capsule of claim 19, wherein an end of the hollow shaft of the piston opposite the plate extends outwardly from an opening of the inner hollow tube adjacent the annular web.

24. The capsule of claim 19, further comprising a second shoulder on the inner face of the outer body adjacent the sealing lip, wherein interaction of the sealing lip and second shoulder forms a second latch.

25. The capsule of claim 24, wherein the sealing lip further comprises a substantially ring shape.

26. The capsule of claim 24, wherein the sealing lip further comprises:
a transitory portion comprising an outer face tilted relative to the outer body inner face; and
an end portion that is substantially parallel to the outer body inner face.

27. The capsule of claim 19, further comprising a snapping engagement between the outer body and the sealing lip.

28. The capsule of claim 19, further comprising:
a container comprising a neck with an opening;
a product contained in the container;
a trigger sprayer attached to the neck of the container; and
wherein the capsule is seated in the opening of the neck of the container.

29. A dispenser, comprising:
a container comprising a neck;
a product in the container;
a trigger sprayer mounted to the neck of the container; and
a capsule seated on the neck of the container between the container and the trigger sprayer and extending into the container, comprising:
a body, comprising:
an outer body defining a top open end and a bottom open end;
an annular web adjacent the top open end and extending inwards from the outer body;
an inner hollow tube extending from the annular web towards the bottom open end; and
a flange extending off the top open end and seated on a portion of the neck of the container;
a piston seated in the inner hollow tube, comprising:
a hollow shaft;
a plate extending outwardly from the hollow shaft on an end of the piston exiting the inner hollow tube adjacent the bottom open end;
a sealing lip extending downwardly from the plate and engaging an inner face of the outer body; and
a shock absorbing feature extending downwardly off the plate and extending past the bottom of said body.
